(19) United States
(12) Patent Application Publication
(10) Pub. No.: US 2026/0292582 A1
(43) Pub. Date: Sep. 24, 2026

(54) VEHICLE MANAGEMENT APPARATUS

(71) Applicant: TOYOTA JIDOSHA KABUSHIKI KAISHA, Toyota-shi (JP)

(72) Inventors: Yuki OKAMOTO, Ebina-shi (JP); Daisuke KAKUMA, Numazu-shi (JP); Takeshi KANOU, Seto-shi (JP); Yuto HARA, Susono-shi (JP); Amane YAJIMA, Ashigara-gun (JP); Sen YANG, Susono-shi (JP); Daiki KUBOTA, Numazu-shi (JP); Ibrahim Takbir NAUFAL, Numazu-shi (JP)

(73) Assignee: TOYOTA JIDOSHA KABUSHIKI KAISHA, Toyota-shi (JP)

(21) Appl. No.: 19/534,106

(22) Filed: Feb. 9, 2026

(30) Foreign Application Priority Data
Mar. 21, 2025 (JP) 2025-046219

(51) Int. Cl. H04W 28/02; H04W 4/46

(52) U.S. Cl. CPC H04W 28/0226; H04W 4/46

(57) ABSTRACT

A vehicle management apparatus according to the present disclosure includes: a communication unit configured to perform communication with a plurality of vehicles which can move by unmanned driving; a determining unit configured to determine a communication status between the communication unit and each of the plurality of vehicles at a time interval corresponding to each traveling area of the plurality of vehicles; and a control unit configured to instruct, via the communication unit, a vehicle, which is determined to have communication interruption with the communication unit, of the plurality of vehicles to perform a predetermined operation.

### CROSS REFERENCE TO RELATED APPLICATIONS

This application is based upon and claims the benefit of priority from Japanese patent application No. 2025-04629, filed on March 21, 2025, the disclosure of which is incorporated herein in its entirety by reference.

### BACKGROUND

The present disclosure relates to a vehicle management apparatus.

In recent years, a management system for remotely controlling the operation of a plurality of vehicles (i.e., self-propelled conveyance vehicles) which can move by unmanned driving has been developed. For example, an apparatus for remotely controlling a mobile body is disclosed in patent literature 1.

[Patent Literature 1] Japanese Patent No. 7424535

### SUMMARY

A management system for remotely managing the operations of a plurality of self-propelled conveyance vehicles is required to appropriately manage self-propelled conveyance vehicles when communication with the self-propelled conveyance vehicles is interrupted, thereby ensuring safety while suppressing an increase in cost.

An object of the present disclosure is to provide a vehicle management apparatus adapted to appropriately manage a self-propelled conveyance vehicle when communication with the self-propelled conveyance vehicle is interrupted.

An vehicle management apparatus according to the present disclosure includes: a communication unit configured to perform communication with a plurality of vehicles which can move by unmanned driving; a determining unit configured to determine a communication status between the communication unit and each of the plurality of vehicles at a time interval corresponding to each traveling area of the plurality of vehicles; and a control unit configured to instruct, via the communication unit, a vehicle, which is determined to have communication interruption with the communication unit, of the plurality of vehicles to perform a predetermined operation. The vehicle management apparatus according to the present disclosure can reduce the frequency of emergency stop of self-propelled conveyance vehicles by lengthening the time interval for determining the communication status to allow a short period of communication interruption, for example, in a state where there are no obstacles (including other self-propelled conveyance vehicles) nearby the vehicle whose communication status is to be determined. This improves the productivity of vehicles and reduces cost. The vehicle management apparatus according to the present disclosure can further reliably prevent contact with an obstacle by shortening the time interval for determining the communication status and not allowing a short period of communication interruption in a state where there is an obstacle nearby the vehicle whose communication status is to be determined. This makes it possible to ensure safety. That is, the management apparatus according to the present disclosure determines the communication status (presence or absence of communication interruption) with the self-propelled conveyance vehicle at a determination interval corresponding to the traveling area of the self-propelled conveyance vehicle, and can appropriately manage the self-propelled conveyance vehicle when communication with the self-propelled conveyance vehicle is interrupted.

According to the present disclosure, it is possible to provide a vehicle management apparatus adapted to appropriately manage a self-propelled conveyance vehicle when communication with the self-propelled conveyance vehicle is interrupted.

The above and other objects, features and advantages of the present disclosure will become more fully understood from the detailed description given hereinbelow and the accompanying drawings.

### BRIEF DESCRIPTION OF DRAWINGS

FIG. 1 is a schematic diagram showing a part of a vehicle management system according to a first embodiment;

FIG. 2 is a block diagram showing a control system of the vehicle management system according to the first embodiment;

FIG. 3 is a diagram for explaining travel control of a vehicle;

FIG. 4 is a control block diagram for explaining a travel control example 1;

FIG. 5 is a flowchart for explaining the travel control example 1;

FIG. 6 is a control block diagram for explaining a travel control example 2; and

FIG. 7 is a flowchart for explaining the travel control example 2.

### DESCRIPTION OF EMBODIMENTS

Hereinafter, specific embodiments to which the present disclosure is applied will be described in detail with reference to the drawings. However, the present disclosure is not limited to the following embodiments. Further, in order to clarify the description, the following description and drawings are appropriately simplified.

### First Embodiment

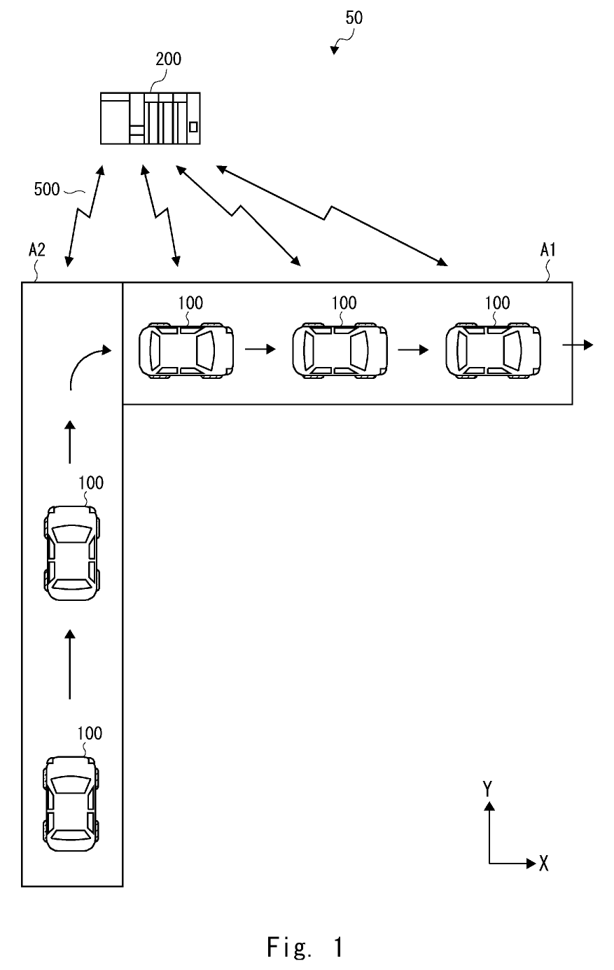

FIG. 1 is a schematic diagram showing a part of a vehicle management system 50 according to a first embodiment. The vehicle management system 50 is applied, for example, in a vehicle manufacturing factory which manufactures a plurality of vehicles 100. In the example shown FIG. 1, the vehicle management system 50 monitors and manages a plurality of vehicles 100 moving in areas A1 and A2. For example, area A1 is an area where predetermined work is performed on each vehicle 100. Area A2 is an area where no predetermined work is performed on each vehicle 100. That is, area A2 is an area where each vehicle 100 simply moves toward area A1. For the sake of explanation an XY orthogonal coordinate system is shown in FIG. 1.

As shown in FIG. 1, the vehicle management system 50 includes a server 200 and a plurality of vehicles 100. Each vehicle 100 is, for example, a self-propelled vehicle which can travel itself during a manufacturing process. In other words, each vehicle 100 is, for example, a vehicle which can move by unmanned driving during a manufacturing process.

Each vehicle 100 is an unfinished vehicle. Each unfinished vehicle 100 is manufactured as a completed product by a worker (not shown) or a robot (not shown) performing predetermined work on each vehicle 100 in each manufacturing process area while moving in platooning along a predetermined traveling route (traveling path). The predetermined work include assembly of parts, switch operation, welding, inspection, and the like.

Each vehicle 100 has an environmental sensor mounted thereon. An environmental sensor includes, for example, a vehicle-mounted camera for photographing the surroundings of a vehicle, a radar for detecting obstacles around a vehicle, and a LiDAR (Light Detection And Ranging) for detecting obstacles around a vehicle. Each vehicle 100 uses an environmental sensor to detect a vehicle traveling ahead of (or behind) the vehicle 100 traveling in platooning, or to detect other obstacles around the vehicle body. For example, each vehicle 100 uses a vehicle-mounted camera, which is an example of environmental sensors, to photograph a vehicle 100 ahead of (or behind) the respective vehicles 100 traveling in platooning. Each vehicle 100 has a communication function and transmits a detection result (data such as a photographed image, for example) of an environmental sensor to the server 200 via a network 500.

The server 200 monitors and manages the plurality of vehicles 100 moving in the area A1 on the basis of the detection results of photographed images or the like received from respective environmental sensors of the plurality of vehicles 100 moving in the area A1. The server 200 monitors and manages the plurality of vehicles 100 moving in the area A2 on the basis of the detection results of photographed images or the like received from respective environmental sensors of the plurality of vehicles 100 moving in the area A2. The server 200 monitors whether or not the respective vehicles 100 is moving on a planned route, or whether or not scheduled work is performed on the respective vehicles 100. The server 200 controls the movement of the respective vehicles 100 while estimating the position of the respective vehicles 100 on the basis of the received photographed images or the like. The server 200 is a vehicle management apparatus, which is also referred to as a vehicle management system by itself.

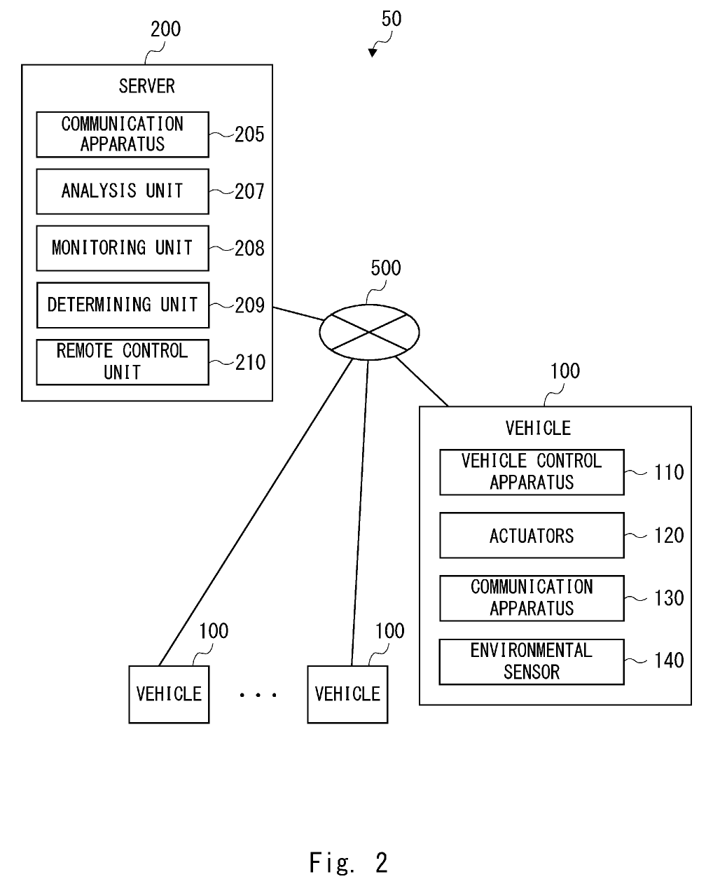

Next, a control system of the vehicle management system 50 will be described with reference to FIG. 2. FIG. 2 is a block diagram showing a control system of the vehicle management system 50.

As shown in FIG. 2, the server 200 includes at least a communication apparatus 205, an analysis unit 207, a monitoring unit 208, a determining unit 209, and a remote control unit 210. The server 200 is not limited to a case where it is physically constituted by a single apparatus, but may be constituted by a plurality of discrete apparatuses. Each vehicle 100 includes a vehicle control apparatus 110, actuators 120, a communication apparatus 130, and an environmental sensor 140. As already described, examples of the environmental sensor 140 include a plurality of types of sensors such as an on-vehicle camera, a radar, and a LiDAR. Each vehicle 100 uses the environmental sensor 140 to detect a vehicle 100 ahead of (or behind) the vehicles 100 traveling in platooning, or to detect other obstacles around a vehicle body.

In the server 200, the communication apparatus 205 communicates with each vehicle 100 via the network 500. For example, the communication apparatus 205 receives a detection result of the environmental sensor 140 (information regarding obstacles around a vehicle body) from each vehicle 100, or transmits information regarding vehicle control to the respective vehicles 100.

The analysis unit 207 analyzes a detection result of the environmental sensor 140 mounted on each vehicle 100 moving in the area A1, and a detection result of the environmental sensor 140 mounted on each vehicle 100 moving in the area A2. Specifically, the communication apparatus 205 receives a detection result (data such as a photographed image) of the environmental sensor 140 mounted on each vehicle 100 moving in the area A1, and a detection result (data such as a photographed image) of the environmental sensor 140 mounted on each vehicle 100 moving in the area A2. The analysis unit 207 analyzes the received detection result to specify, for example, the outer shape of a vehicle ahead of (or behind) the respective vehicles 100, the surrounding environment of the respective vehicles 100, and the like. As a result, it is possible to specify the following distance between a vehicle 100 and a vehicle ahead of (or behind) the vehicle 100 in the area A1, the position and orientation of the respective vehicles 100 in the area A1, the traveling state of the respective vehicles 100 in the area A1, and the like. Similarly, it is possible to specify the following distance between a vehicle 100 and a vehicle ahead of (or a vehicle behind) the vehicle 100 in the area A2, the position and orientation of the respective vehicles 100 in the area A2, the traveling state of the respective vehicles 100 in the area A2, and the like.

The monitoring unit 208 monitors each vehicle 100 moving in the areas A1 and A2 based on the analysis result of the analysis unit 207. For example, the monitoring unit 208 monitors whether or not each vehicle 100 is moving while keeping a predetermined following distance between the vehicles, whether or not each vehicle 100 is moving on a planned route, and whether or not scheduled work is performed on the respective vehicles 100.

The remote control unit 210 remotely controls each vehicle 100 by transmitting information related to vehicle control to each vehicle 100 based on the result of monitoring by the monitoring unit 208 (including position information of each vehicle 100). Specifically, the communication apparatus 205 transmits information related to vehicle control instructed by the remote control unit 210 to each vehicle 100. In each vehicle 100, the communication apparatus 130 receives the information related to vehicle control from the server 200, and the vehicle control apparatus 110 makes the vehicle travel under the control of the actuators 120 according to the information related to vehicle control.

The determining unit 209 determines the communication status between the communication apparatus 205 and each of the plurality of vehicles 100. In other words, the determining unit 209 determines whether or not there is a communication interruption between the communication apparatus 205 and each of the plurality of vehicles 100. Then, the remote control unit 210 instructs, via the communication apparatus 205, a vehicle 100 among the plurality of vehicles 100, which is determined to have a communication interruption with the communication apparatus 205, to perform a predetermined operation.

For example, the remote control unit 210 instructs vehicle 100, which is determined to have a communication interruption with the communication apparatus 205, to make an emergency stop. Alternatively, the remote control unit 210 instructs a vehicle 100, which is determined to have a communication interruption with the communication apparatus 205, to stop traveling after completing the predetermined operation in progress. Alternatively, the remote control unit 210 instructs a vehicle 100, which is determined to have a communication interruption with the communication apparatus 205, to go off the planned traveling route of another vehicle 100 traveling behind the vehicle 100 having a communication interruption and then stop traveling.

Alternatively, the remote control unit 210 may instruct all vehicles 100 moving in the area where a vehicle 100, which is determined to have a communication interruption with the communication apparatus 205, is located to stop traveling. For example, in the case where the determining unit 209 determines that communication between any of the vehicles 100 moving in the area A1 and the communication apparatus 205 is interrupted, the remote control unit 210 may instruct all vehicles 100 moving in the area A1 to stop traveling.

Here, the communication status (presence or absence of communication interruption) between the communication apparatus 205 and each of the plurality of vehicles 100 is determined at a time interval (cycle) corresponding to each traveling area of the plurality of vehicles 100.

For example, as shown in FIG. 1, in the area A1 where predetermined work is performed on each vehicle 100, it is prone to be crowded with vehicles. That is, the following distance between vehicles tends to be short in the area A1. Therefore, the determining unit 209 determines the communication status between the communication apparatus 205 and the respective vehicles 100 moving in the area A1 at relatively short time intervals. That is, the server 200 shortens the interval for determining the communication status (presence or absence of communication interruption) between the communication apparatus 205 and the respective vehicles 100 moving in the area A1 so as not to allow a short period of communication interruption, thereby more reliably preventing each vehicle 100 moving in the area A1 from coming into contact with its adjacent vehicle. Thus, safety can be ensured.

On the other hand, in the area A2 where the predetermined work is not performed the respective vehicles 100, the following distance between the vehicles tends to be long. Therefore, the determining unit 209 determines the communication status between the communication apparatus 205 and each vehicle 100 moving in the area A2 at a relatively long time interval. That is, by lengthening the interval for determining the communication status between the communication apparatus 205 and each vehicle 100 moving in the area A2 and allowing a communication interruption for a short time in the range where the vehicles do not come into contact with each other, the server 200 can reduce the frequency of the emergency stop of each vehicle 100 moving in the area A2. This improves the productivity of the vehicles and contributes to cost reduction.

That is, in the case where communication between the communication apparatus 205 and any one of the plurality of vehicles 100 is interrupted, the server 200 can appropriately manage the vehicle 100 in which the communication has been interrupted.

As described above, the vehicle management system 50 according to the present disclosure determines the communication status (presence or absence of communication interruption) between the server 200 and each of the plurality of vehicles 100 at a time interval corresponding to each traveling area of the plurality of vehicles 100. Thus, in the case where communication between the server 200 and any one of the plurality of vehicles 100 is interrupted, the vehicle management system 50 according to the present disclosure can appropriately manage the vehicle 100 in which the communication has been interrupted.

In the present disclosure, a case where the server 200 uniformly shortens the communication status determination interval between the communication apparatus 205 and each of the plurality of vehicles 100 traveling in the area A1 having a short following distance and uniformly lengthens interval at which the communication status determination interval between the communication apparatus 205 and each of the plurality of vehicles 100 traveling in the area A2 having a long following distance has been described as an example, but is not limited thereto. The server 200 may adjust the communication status determination interval for each vehicle 100 traveling in the area A1 according to the degree of approach of a surrounding obstacle (including another vehicle) detected by the environmental sensor 140 of each vehicle 100 traveling in the area A1. Similarly, the server 200 may adjust the communication status determination interval for each vehicle 100 traveling in the area A2 according to the degree of approach of a surrounding obstacle (including another vehicle) detected by the environmental sensor 140 of each vehicle 100 traveling in the area A2.

Further, in the present disclosure, an example has been described in which the server 200 shortens the time interval for determining the communication status as the following distance between vehicle 100, which is the object of communication status determination, and the adjacent vehicle becomes shorter, and lengthens the time interval for determining the communication status as the following distance between vehicle 100, which is the object of communication status determination, and the adjacent vehicle becomes longer. The server 200 may determine the time interval for determining the communication status according to the distance between vehicle 100, which is the object of communication status determination, and an obstacle other than the adjacent vehicle. Specifically, the server 200 may shorten the time interval for determining the communication status as the distance between vehicle 100, which is the object of communication status determination, and an obstacle other than the adjacent vehicle becomes shorter, and lengthen the time interval for determining the communication status as the distance between vehicle 100, which is the object of communication status determination, and an obstacle other than the adjacent vehicle becomes longer. Examples of the obstacles other than the adjacent vehicle include workers, work robots, tool storage areas, and the like. For example, the server 200 may set the time interval for determining the communication status of a vehicle 100 traveling in an area where workers are not allowed to enter longer than the time interval for determining the communication status of a vehicle 100 traveling in an area where workers are allowed to enter.

Further, in the present disclosure, a case has been described in which the server 200 shortens the time interval for determining the communication status as the following distance between a vehicle 100 to be determined for the communication status and an adjacent vehicle becomes shorter, and lengthens the time interval for determining the communication status as the following distance between a vehicle 100 to be determined for the communication status and an adjacent vehicle becomes longer. For example, in addition to referring to the following distance between vehicles, the server 200 may shorten the time interval for determining the communication status as the traveling speed of a vehicle 100 to be determined for the communication status increases, and lengthen the time interval for determining the communication status as the traveling speed of a vehicle 100 to be determined for the communication status decreases.

Hereinafter, traveling control examples for controlling the traveling of a vehicle 100 in the vehicle manufacturing system 50 including the vehicle management system according to the present disclosure will be described.

### A. traveling control example 1

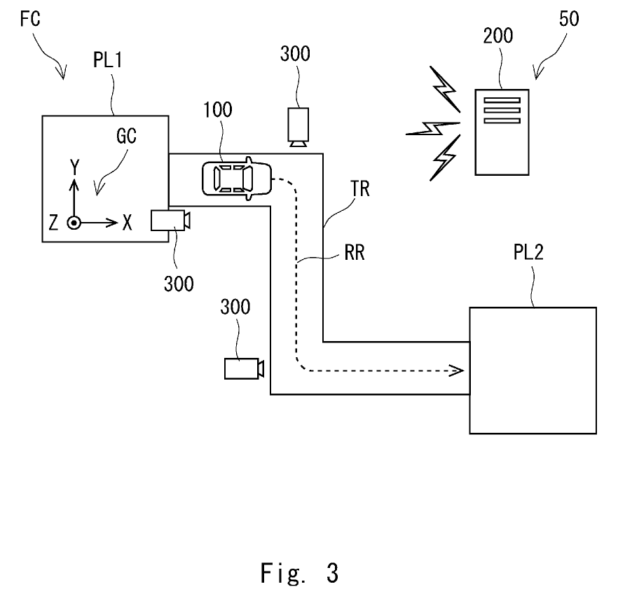

FIG. 3 is a conceptual diagram showing the configuration of the system 50 according to Traveling Control Example 1. The system 50 includes one or more vehicles 100 each serving as a mobile body, the server 200, and one or more external sensors 300.

Note that, in the case where the mobile body is other than a vehicle, the term “vehicle” or “car” in the present disclosure may be replaced by a “mobile body” as appropriate, and the term “travel” may be replaced by “move” as appropriate.

The vehicle 100 is configured to be able to travel by unmanned driving. The “unmanned driving” means driving that is not dependent on driver’s operation. The driving operation means an operation related regarding at least of “running”, “turning”, and “stopping” of the vehicle 100. Unmanned driving is achieved by automatic or manual remote control that uses an apparatus located outside the vehicle 100, or by autonomous control of the vehicle 100. Any passenger who does not perform the traveling operation may ride in the vehicle 100 traveling by unmanned driving. Examples of the passenger who does not perform the traveling operation include a person who is just sitting in a seat of the vehicle 100 and a person who is performing work different from the traveling operation, such as assembly, inspection, and operation of switches, while riding in the vehicle 100. The driving by the traveling operation of a passenger may be referred to as “manned driving”.

In this specification, the “remote control” includes “full remote control” in which all of the operations of the vehicle 100 are completely determined from the outside of the vehicle 100, and “partial remote control” in which some of the operations of vehicle 100 are determined from outside vehicle 100. Further, “autonomous control” includes “full autonomous control” in which the vehicle 100 autonomously controls its own operation without receiving any piece of information from an apparatus located outside the vehicle 100, and “partial autonomous control” in which the vehicle 100 autonomously controls its own operation using information received from an apparatus located outside the vehicle 100.

In this embodiment, the system 50 is used in a factory FC which manufactures the vehicles 100. The reference coordinate system of the factory FC is a global coordinate system GC. That is, a desired position in the factory FC is expressed by coordinates of X, Y, and Z in global coordinate system GC. The factory FC includes a first place PL1 and a second place PL2. The first place PL1 and the second place PL2 are connected to each other by a traveling path TR along which the vehicle 100 can travel. A plurality of external sensors 300 are installed in along the traveling path TR the factory FC. The positions of the respective external sensors 300 in the factory FC are adjusted in advance. The vehicle 100 is moves from the first place PL1 to the second place PL2 along the traveling path TR by unmanned driving.

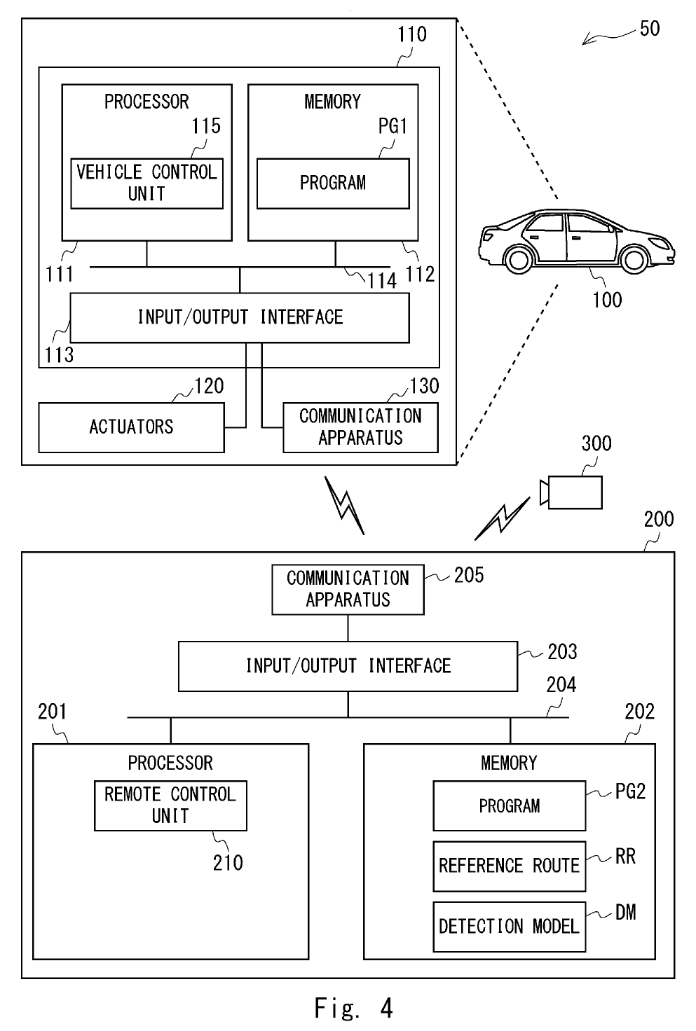

FIG. 4 is a block diagram showing the configuration of the system 50. The vehicle 100 includes the vehicle control apparatus 110 for controlling each part of the vehicle 100, the actuators 120 including one or more actuators that drive under a control of the vehicle control apparatus 110, and the communication apparatus 130 for communicating with an external apparatus such as the server 200 by wireless communication. The actuators 120 include an actuator of a driving apparatus for accelerating the vehicle 100, an actuator for a steering apparatus for changing a traveling direction of the vehicle 100, and an actuator of control apparatus for decelerating the vehicle 100.

The vehicle control apparatus 110 is composed of a computer including a processor 111, a memory 112, an input/output interface 113, and an internal bus 114. The processor 111, the memory 112, and the input/output interface 113 are connected to one another via the internal bus 114 in such a way that they can communicate with one another. The actuators 120 and the communication apparatus 130 are connected to the input/output interface 113. The processor 111 executes a program PG1 stored in the memory 112, thereby implementing various functions including a function as a vehicle control unit 115.

The vehicle control unit 115 causes the vehicle 100 to travel by controlling the actuators 120. The vehicle control unit 115 is able to cause the vehicle 100 to travel by controlling the actuators 120 using a traveling control signal received from the server 200. The traveling control signal is a control signal for causing the vehicle 100 to travel. In this embodiment, the traveling control signal includes an acceleration and a steering angle of the vehicle 100 as parameters. In another embodiment, the traveling control signal may include, in place of or in addition to the acceleration of the vehicle, a speed of vehicle 100 as a parameter.

The server 200 is composed of a computer including a processor 201, a memory 202, an input/output interface 203, and an internal bus 204. The processor 201, the memory 202, and the input/output interface 203 are connected to one another via the internal bus 204. The communication apparatus 205 for communicating with various types of apparatuses located outside the server 200 is connected to the input/output interface 203. The communication apparatus 205 can communicate with the vehicle 100 by wireless communication, and can communicate with each of the external sensors 300 by wired communication or wireless communication. The processor 201 executes a program PG2 stored in the memory 202, thereby implementing various functions including a function as the remote control unit 210.

The remote control unit 210 acquires a detection result by the sensor, generates a traveling control signal for controlling the actuators 120 of vehicle 100 by using the detection result, and transmits a traveling control signal to vehicle 100 to drive vehicle 100 by remote control. Further, the remote control unit 210 may generate and output a control signal for controlling actuators for operating not only traveling control signal but also various auxiliary equipment provided in vehicle 100, for example, or various equipment such as a wiper, a power window, and a lamp. That is, the remote control unit 210 may operate these various equipment and various auxiliary equipment by remote control. For example, the remote control unit 210 may include functions of the analysis unit 207, the monitoring unit 208, and the determining unit 209 shown separately from the remote control unit 210 in FIG. 2.

An external sensor 300 is a sensor located outside vehicle 100. The external sensor 300 according to this embodiment is a sensor that captures the vehicle 100 from outside of the vehicle 100. The external sensor 300 includes a communication apparatus (not shown), and can communicate with other apparatuses such as the server 200 through wired communication or wireless communication.

Specifically, the external sensor 300 is composed of a camera. The camera as the external sensor 300 captures an image including the vehicle 100 and outputs the captured image as a result of detection.

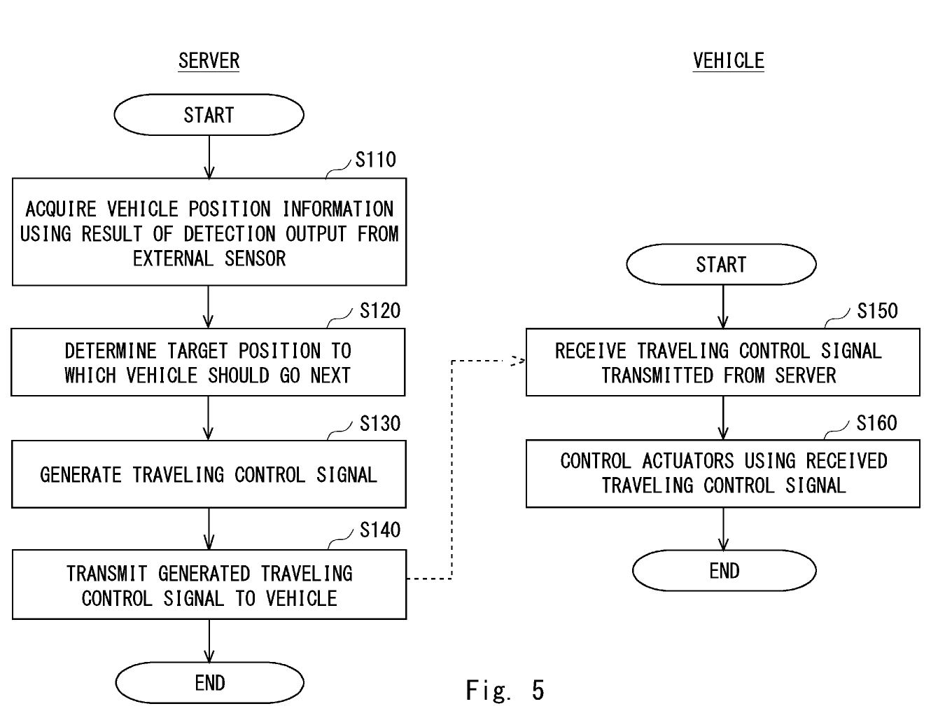

FIG. 5 is a flowchart showing a processing procedure of traveling control of the vehicle 100 according to the traveling control example. In the processing procedure shown in FIG. 5, the processor 201 of the server 200 functions as the remote control unit 210 by executing the program PG2. Further, the processor 111 of the vehicle 100 functions as the vehicle control unit 115 by executing the program PG1.

In Step S110, the processor 201 of the server 200 acquires vehicle position information of the vehicle 100 using a result of detection output from the external sensor 300. The vehicle position information is position information based on which a traveling control signal is generated. In this embodiment, the vehicle position information includes the position and the orientation of the vehicle 100 in the global coordinate system GC of the factory FC. Specifically, in Step S110, the processor 201 acquires the vehicle position information using the captured image acquired from the camera, which is the external sensor 300.

More specifically, in Step S110, the processor 201 detects, for example, the external shape of the vehicle 100 from the captured image, calculates a coordinate system of the captured image, that is, coordinated of the positioning points of the vehicle in a local coordinate system, and converts the calculated coordinates into coordinates in the global coordinate system GC, thereby acquiring the position of the vehicle 100. The external shape of the vehicle 100 included in the captured image can be detected by, for example, inputting the captured image to a detection model DM that uses artificial intelligence. The detection model DM is prepared, for example, in the system 50 or outside of the system 50, and is stored in the memory 202 of the server 200 in advance. Examples of the detection model DM include a trained machine learning model that has been trained so as to implement one of semantic segmentation and instance segmentation. For example, convolutional neural network (hereinafter referred to as CNN) trained by supervised learning using a learning dataset may be used as this machine learning model. The learning dataset includes, for example, a plurality of training images including the vehicle 100, and a label indicating whether each area in the training image is an area indicating the vehicle 100 or an area indicating a region other than the vehicle 100. In performing CNN learning, parameters of the CNN are preferably updated in such a way that the error between the result output by the detection model DM and the label is reduced by backpropagation (error backpropagation method). Further, the processor 201 is able to acquire the orientation of the vehicle 100 by estimating it based on the direction of the movement vector of the vehicle 100 calculated from changes in positions of the feature points of the vehicle 100 between frames of the captured image using, for example, an optical flow method.

In Step S120, the processor 201 of the server 200 determines a target position to which vehicle 100 should go next. In this embodiment, the target position is expressed by coordinates of X, Y, and Z in the global coordinate system GC. The memory 202 of the server 200 stored in advance a reference route RR, which is a route along which vehicle 100 should travel. The route is expressed by a node indicating a departure place, nodes indicating passage points, a node indicating a destination, and links connecting the respective nodes. The processor 201 determines the target position to which the vehicle 100 should go next using the vehicle position information and the reference route RR. The processor 201 determines a position ahead of the current position of the vehicle 100 on the reference route RR as the target position.

In Step S130, the processor 201 of the server 200 generates a traveling control signal for causing the vehicle 100 to travel toward the determined target position. The processor 201 calculates a traveling speed of the vehicle 100 from the transition of the positions of the vehicle 100 and compares the calculated traveling speed with a target speed. In general, in the case where the traveling speed is lower than the targe speed, the processor 201 determines the acceleration in such a way that that the vehicle 100 accelerates, while in the case where the traveling speed is higher than the target speed, the processor determines the acceleration in such a way that the vehicle 100 decelerates. Further, in the case where the vehicle 100 is positioned on the reference route RR, the processor 201 determines the steering angle and the acceleration in such a way that the vehicle 100 is prevented from being deviated from the reference route RR, while in the case where the vehicle 100 is not positioned on the reference route RR, that is, in the case where the vehicle is deviated from the reference route RR, the processor 201 determines the steering angle and the acceleration in such a way that the vehicle 100 returns onto the reference route RR.

In Step S140, the processor 201 of the server 200 transmits the generated traveling control signal to the vehicle 100. The processor 201 repeats, in a predetermined cycle, acquisition of the position of the vehicle 100, determination of the target position, generation of a traveling control signal, transmission of the traveling control signal, and the like.

In Step S150, the processor 111 of the vehicle 100 receives the traveling control signal transmitted from the server 200. In Step S160, the processor 111 of the vehicle 100 controls the actuators 120 using the received traveling control signal, thereby causing the vehicle 100 to travel at the acceleration and the steering angle indicated in the traveling control signal. The processor 111 repeats reception of the traveling control signal and control of the actuators 120 in predetermined cycle. By the system 50 according to this embodiment, it is possible to cause the vehicle 100 to travel by remote control, and thus to move the vehicle 100 without using conveyance equipment such as cranes or conveyors.

### B: Traveling Control Example 2

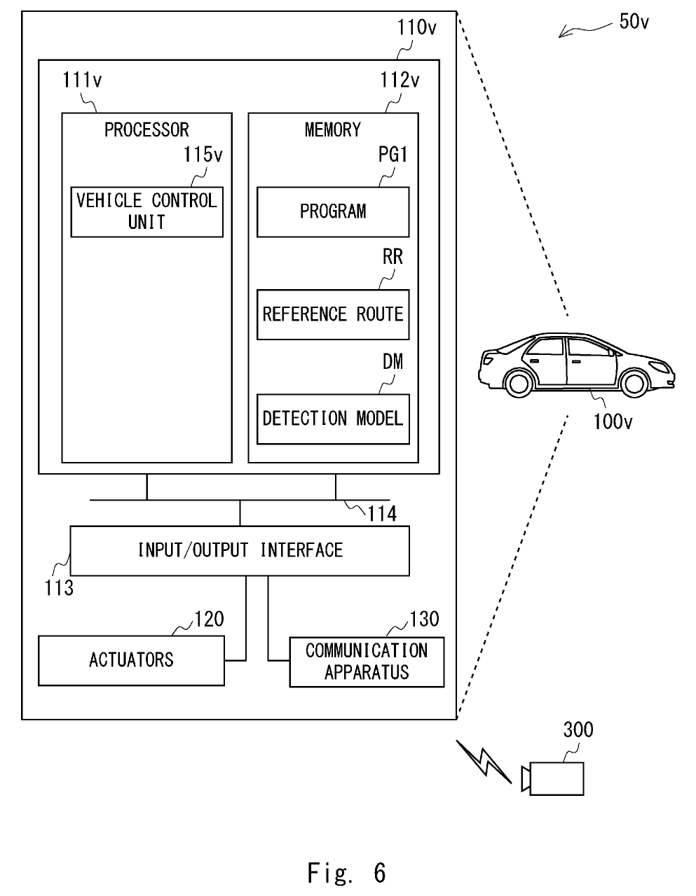

FIG. 6 is an explanatory diagram showing a schematic configuration of a system 50v according to a traveling control example 2. In this embodiment, the system 50v is different from the system 50 according to the traveling control example 1 in that it does not include the server 200. Further, the vehicle 100v has a configuration in which it can travel under its autonomous control. The other configurations are the same as those stated above unless otherwise described.

In this example, a processor 111v of a vehicle control apparatus 110v functions as a vehicle control unit 115v by executing the program PG1 stored in a memory 112v. The vehicle control unit 115v acquires a result output by a sensor, generates a traveling control signal using the output result, and outputs the generated traveling control signal to operate the actuators 120, thereby enabling the vehicle 100v to travel by autonomous control. In this example, the memory 112v stores in advance the detection model DM and the reference route RR in addition to the program PG1.

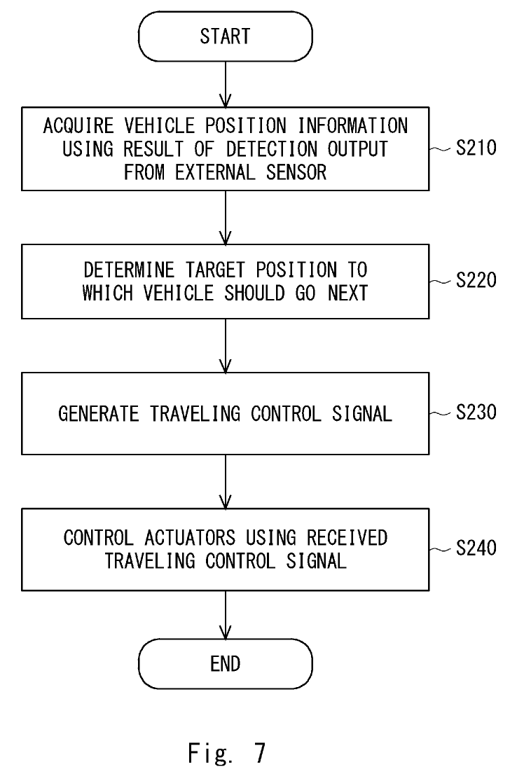

FIG. 7 is a flowchart showing a processing procedure of traveling control of the vehicle 100v according to the traveling control example 2. In the processing procedure shown in FIG. 7, the processor 111v of the vehicle 100v functions as the vehicle control unit 115v by executing the program PG1.

In Step S210, the processor 111v of the vehicle control apparatus 110v acquires vehicle position information using a detection result output from a camera, which is the external sensor 300. In Step S220, the processor 111v determines a target position to which the vehicle 100v should go next. In Step S230, the processor 111v generates a traveling control signal for causing the vehicle 100v toward the determined target position. In Step S240, the processor 111v controls the actuators 120 using the generated traveling control signal, thereby causing the vehicle 100v to travel in accordance with parameters indicated in the traveling control signal. The processor 111v repeats acquisition of the vehicle position information, determination of the target position, generation of a traveling control signal, and control of the actuators in a predetermined cycle. By the system 50v according to this example, it is possible to cause the vehicle 100v to travel by autonomous control of the vehicle 100v without remotely controlling vehicle 100v by the server 200.

### YY: Other Traveling Control Examples

(YY1) In the above examples, the external sensor 300 is a camera. However, the external sensor 300 may not be a camera, and may be, for example, a Light Detection And Ranging (LiDAR). In this case, the result of the detection result output from the external sensor 300 may be three-dimensional point cloud data indicating the vehicle 100. In this case, the server 200 and the vehicle 100 may acquire the vehicle position information by template matching that uses three-dimensional point cloud data obtained as the result of as the detection and reference point cloud data prepared in advance.

(YY2) In the traveling control example 1, the server 200 executes processes from the acquisition of the vehicle position information to the generation of a traveling control signal. However, the vehicle 100 may execute at least some of the processes from the acquisition of the vehicle position information to the generation of a traveling control signal. For example, the following (1) to (3) may be employed.
(1) The server 200 may acquire vehicle position information, determine a target position to which the vehicle 100 should go next, and generate a route from the current position of the vehicle 100 indicated in the acquired vehicle position information to the target position. The server 200 may generate a route to the target position between the current position and the destination, or may generate a route to the destination. The server 200 may transmit the generated route to the vehicle 100. The vehicle 100 may generate a traveling control signal for causing the vehicle 100 to travel along the route received from the server 200, and control the actuators 120 using the generated traveling control signal.
(2) The server 200 may acquire vehicle position information and transmit the acquired vehicle position information to the vehicle 100. The vehicle 100 may determine a target position to which the vehicle 100 should go next, generate a route from the current position of the vehicle 100 indicated in the received vehicle position information to the target position, generate a traveling control signal for causing the vehicle 100 to travel along the generated route, and control the actuators 120 using the generated traveling control signal.
(3) In the above forms (1) and (2), an internal sensor may be mounted on the vehicle 100, and a result of detection output from the internal sensor may be used in at least one of generation of a route and the generation of a traveling control signal. The internal sensor is a sensor mounted on the vehicle 100 and corresponds to the environmental sensor 140 shown in FIG. 2. Examples of the internal sensor may include a sensor that detects a motion state of the vehicle 100, a sensor that detects an operation state of each part of the vehicle 100, and a sensor that detects an environment near the vehicle 100. Specifically, examples of the internal sensor may include, for example, a camera, a LiDAR, a millimeter-wave radar, an ultrasonic sensor, a GPS sensor, an acceleration sensor, and a gyro sensor. For example, in the form (1), the server 200 may acquire a result of detection by the internal sensor, and reflect the result of the detection by the internal sensor in a route when the route is generated. In the above form (1), the vehicle 100 may acquire a result of detection by the internal sensor, and reflect the result of the detection by the internal sensor in a traveling control signal when the traveling control signal is generated. In the above form (2), the vehicle 100 may acquire a result of detection by the internal sensor, and reflect the result of the detection of the internal sensor in a route when the route is generated. In the above form (2), the vehicle 100 may acquire a result of detection by the internal sensor and, reflect the result of the detection of the internal sensor in a traveling control signal when the traveling control signal is generated.

(YY3) In the traveling control example 2, an internal sensor may be mounted on the vehicle 100v and a result of detection output from the internal sensor may be used in at least one of the generation of a route and the generation of a traveling control signal. For example, the vehicle 100v may acquire a result of detection by the internal sensor, and reflect the result of detection by the internal sensor in a route when the route is generated. The vehicle 100v may acquire a result of detection by the internal sensor and reflect the result of the detection of the internal sensor in a traveling control signal when the traveling control signal is generated.

(YY4) In traveling control example 2, the vehicle 100v acquires vehicle position information using a result of detection by the external sensor 300. On the other hand, an internal sensor may be mounted on the vehicle 100v, and the vehicle 100v may acquire vehicle position information using a result of detection by the internal sensor, determine a target position to which vehicle 100v should go next, generate a route from the current position of the vehicle 100v indicated in the acquired vehicle position information to the target position, generate a traveling control signal for the vehicle 100v to travel along the generated route, and control the actuators 120 using the generated traveling control signal. In this case, the vehicle 100v can travel without using any result of detection by the external sensor 300. Note that the vehicle 100v may acquire a target arrival time and the congestion information from outside the vehicle 100v and reflect the target arrival time and the congestion information in at least one of the route and the traveling control signal. Further, all the functional configurations of the system 50v may be provided in the vehicle 100v. That is, the processes implemented by the system 50v in the present disclosure may be implemented by the vehicle 100v alone.

(YY5) In traveling control example 1, the server 200 automatically generates a traveling control signal to be transmitted to the vehicle 100. However, the server 200 may generate a traveling control signal to be transmitted to the vehicle 100 in accordance with an operation performed by an external operator present outside the vehicle 100. For example, the external operator may operate a controlling apparatus including a display for displaying a captured image output from the external sensor 300, a steering, an accelerator pedal, and a brake pedal for remotely controlling the vehicle 100, and a communication apparatus for communicating with the server 200 by wired communication or wireless communication, and the server 200 may generate a traveling control signal corresponding to the operation performed with regard to the controlling apparatus.

(YY6) In each of the above traveling control examples, the vehicle 100 only needs to have a configuration in which it can move by unmanned driving, and a form of the platform of the vehicle 100 may have, for example, configurations described below. Specifically, the vehicle 100 only needs to include at least the vehicle control apparatus 110 and the actuators 120 in order to perform three functions of “running”, “turning”, and “stopping” by unmanned driving. In a case where the vehicle 100 externally acquires information for unmanned driving, the vehicle 100 may further include the communication apparatus 130. That is, the vehicle 100 that can move by unmanned driving may not be provided with at least some of interior components such as a driving seat and a dashboard, at least some exterior components such as a bumper and a fender, and may not have a body shell. In this case, the unmounted components such as the body shell may be mounted on the vehicle 100 before the vehicle 100 is shipped from the factory FC, or the unmounted components such as the body shell may be mounted on the vehicle 100 after the vehicle 100 is shipped from the factory FC in a state where the unmounted components such as the body shell are not mounted on the vehicle 100. The components may be mounted on the vehicle 100 from desired directions thereof, for example, from an upper side, a lower side, a front side, a rear side, a right side, or a left side. They may also be mounted on the vehicle 100 from the same direction or from different directions. Note that regarding the form of the platform, the position may be determined like in the case of the vehicle 100 according to the first embodiment.

(YY7) The vehicle 100 may be manufactured by combining a plurality of modules with one another. The module means a unit formed of a plurality of components grouped in accordance with a part or a function of the vehicle 100. For example, the platform of the vehicle 100 may be manufactured by combining a front module that forms a front part of the platform, a central module forms a central part of the platform, and a rear module that forms a rear part of the platform with one another. Note the number of modules that form the platform is not limited to three, but may instead be two or smaller or four or larger. Further, in addition to or in place of the components that form the platform, components of the vehicle 100 that form the parts thereof other than the platform may be formed in the form of a module. Further, the above various modules may include any exterior components such as a bumper or a grill or any interior components such as seats and consoles. Further, not only the vehicle 100, but also a mobile body of any form may be manufactured by combining a plurality of modules with one another. Each of these modules may be manufactured, for example, by joining a plurality of components by welding, fixtures, or the like, or manufactured by integrally molding at least some of the components that form the module as one component by casting. A molding method for integrally molding components as one component, in particular, as a relatively large-sized component, is also referred to as giga casting or mega casting. For example, the above-described front module, the central module and the rear module may be manufactured using giga casting.

(YY8) Conveyance of the vehicle 100 using the traveling of vehicle 100 by unmanned driving is also called “self-propelled conveyance”. Further, a configuration for achieving the self-propelled conveyance is also called a “vehicle remote control autonomous conveyance system”. Further, a production method for producing the vehicles 100 using the self-propelled conveyance is also referred to as “self-propelled production”. In the self-propelled production, for example, in the factory FC that manufactures the vehicles 100, part of the conveyance of the vehicles 100 is achieved by self-propelled conveyance.

(YY9) In each of the above traveling control examples, some or all of the functions and the processes implemented in the form of software may be implemented in the form of hardware. Some or all of the functions and the processes implemented in the form of hardware may be implemented in the form of software. For example, various types of circuits such as an integrated circuit or a discrete circuit may be used as hardware for implementing various types of functions in each of the in the above embodiments.

Note that, in the present disclosure, some or all of the processes performed in the external sensor 300, the vehicle 100, the server 200, etc. described above can be implemented by causing a Central Processing Unit (CPU) to execute a computer program.

The above-described program includes instructions (or software codes) that, when loaded into a computer, cause the computer to perform one or more of the functions described in the embodiments. The program may be stored in a non-transitory computer readable medium or a tangible storage medium. By way of example, and not a limitation, non-transitory computer readable media or tangible storage media can include a Random-Access Memory (RAM), a Read-Only Memory (ROM), a flash memory, a Solid-State Drive (SSD) or other types of memory technologies, a CD-ROM, a Digital Versatile Disc (DVD), a Blu-ray (Registered Trademark) disc or other types of optical disc storage, a magnetic cassette, a magnetic tape, and a magnetic disk storage or other types of magnetic storage devices. The program may be transmitted on a transitory computer readable medium or a communication medium. By way of example, and not a limitation, transitory computer readable media or communication media can include electrical, optical, acoustical, or other forms of propagated signals.

The present disclosure has been described with reference to embodiments, but the present disclosure is not limited to the above-described embodiments. Various changes that may be understood by those skilled in the art may be made to the configurations and details of the present disclosure within the scope of the present disclosure. Further, each of the embodiments may be combined with at least one of the other embodiments as appropriate.

From the disclosure thus described, it will be obvious that the embodiments of the disclosure may be varied in many ways. Such variations are not to be regarded as a departure from the spirit and scope of the disclosure, and all such modifications as would be obvious to one skilled in the art are intended for inclusion within the scope of the following claims.

What is claimed is:

1. A vehicle management apparatus comprising:
a communication unit configured to perform communication with a plurality of vehicles which can move by unmanned driving;
a determining unit configured to determine a communication status between the communication unit and each of the plurality of vehicles at a time interval corresponding to each traveling area of the plurality of vehicles; and
a control unit configured to instruct, via the communication unit, a vehicle, which is determined to have communication interruption with the communication unit, of the plurality of vehicles to perform a predetermined operation.

2. The vehicle management apparatus according to claim 1, wherein the determining unit shortens the time interval for determining the communication status as a following distance between the target vehicle, which is vehicle to be determined, and another vehicle traveling ahead of the target vehicle becomes shorter.

3. The vehicle management apparatus according to claim 2, wherein the determining unit shortens the time interval for determining the communication status as the traveling speed of the target vehicle increases.

4. The vehicle management apparatus according to claim 1, wherein the control unit is configured to instruct the vehicle determined to have communication interruption with the communication unit to make an emergency stop, to stop traveling after completing the operation in progress, or to go off a planned traveling route of another vehicle traveling behind the vehicle having communication interruption and then stop traveling.

5. The vehicle management apparatus according to claim 1, wherein the control unit is configured to instruct, among the plurality of vehicles, all vehicles in a traveling area where there are vehicles determined to have communication interruption with the communication unit, to stop traveling.
